(19) United States
(12) Patent Application Publication
(10) Pub. No.: US 2026/0105530 A1
(43) Pub. Date: Apr. 16, 2026

(54) INFORMATION PROCESSING APPARATUS, SUPPORT METHOD, AND NON-TRANSITORY COMPUTER-READABLE MEDIUM

(71) Applicant: NEC Corporation, Tokyo (JP)

(72) Inventors: Takuma SATO, Tokyo (JP); Daiki SATO, Tokyo (JP); Etsuko ICHIHARA, Tokyo (JP); Kenei TANABE, Tokyo (JP); Fumihiro TANIGUCHI, Tokyo (JP)

(73) Assignee: NEC Corporation, Tokyo (JP)

(21) Appl. No.: 19/347,814

(22) Filed: Oct. 2, 2025

(30) Foreign Application Priority Data
Oct. 11, 2024 (JP) 2024-179344

(51) Int. Cl. G06Q 40/08; G06F 40/40

(52) U.S. Cl. CPC G06Q 40/0821; G06F 40/40

(57) ABSTRACT

An information processing apparatus includes an acquisition unit that acquires condition information indicating a desired condition of the subject for insurance, and an extraction unit that extracts a related description related to the desired condition from a document describing an insurance product that is a candidate recommended to the subject, using an extraction model with machine learning in such a way as to output a portion related to data in the document using a set of the document and the data as an input. Decision making in a case where the subject selects an insurance product can be supported.

This application is based upon and claims the benefit of priority from Japanese patent application No. 2024-179344, filed on Oct. 11, 2024, the disclosure of which is incorporated herein in its entirety by reference.

### TECHNICAL FIELD

The present disclosure relates to an information processing apparatus, a support method, and a non-transitory computer-readable medium.

### BACKGROUND ART

With diversification of needs for insurance products, a wide variety of insurance products are provided. As a technology for supporting in searching for an insurance product suitable for oneself from among a large number of insurance products, for example, there is an insurance product recommendation system disclosed in WO 2021/084626 A1. The insurance product recommendation system described in WO 2021/084626 A1 uses various types of attribute information such as gender, age, address, and preference of a user to be recommended, and outputs an insurance product suitable for the user.

More specifically, in the insurance product recommendation system described in WO 2021/084626 A1, a large number of insurance products each classified into a main contract, a special agreement, and a service are extracted in advance from a database, and then all patterns of the main contract, the special agreement, and the service are generated. Then, in this insurance product recommendation system, a virtual product suitable for the user is extracted and recommended from the virtual product group including the insurance product group generated as described above by using the attribute information of the user and the recommendation information.

### SUMMARY

In a case where the insurance product recommendation system described in WO 2021/084626 A1 is applied, it is necessary to determine in advance what type of insurance product is recommended to the user of what type of attribute information. However, it is not easy to determine in advance an appropriate insurance product according to the user attribute. In particular, recently, since user attributes including desired conditions for insurance are diversified, it is difficult to cover such various user attributes and propose an appropriate insurance product.

For this reason, under the present circumstances, many people who consider subscribing to an insurance perform complicated work of searching for insurance according to their desired conditions from various insurance product pamphlets or the like. An example object of the present disclosure is to provide a technique that facilitates work of searching for an insurance product that satisfies a desired condition by the subject.

An information processing apparatus according to an example aspect of the present disclosure includes acquisition means for acquiring condition information indicating a desired condition of the subject for insurance, and extraction means for extracting a related description related to the desired condition from a document describing an insurance product that is a candidate recommended to the subject by using an extraction model machine-learned in such a way as to output a portion related to the data in the document using a set of the document and the data as an input.

An information processing apparatus according to an example aspect of the present disclosure includes acquisition means for acquiring condition information indicating a desired condition of the subject for insurance, and determination means for determining whether an insurance product satisfies the desired condition by using a document describing the insurance product and a language model trained by machine learning on natural language.

In a support method according to an example aspect of the present disclosure, at least one processor executes acquisition processing of acquiring condition information indicating a desired condition of the subject for insurance, and extraction processing of extracting a related description related to the desired condition from a document describing an insurance product that is a candidate recommended to the subject by using an extraction model machine learned in such a way as to output a portion related to the data in the document using a set of the document and the data as an input.

A support program according to an example aspect of the present disclosure, causes a computer to function as acquisition means for acquiring condition information indicating a desired condition of the subject for insurance, and extraction means for extracting a related description related to the desired condition from a document describing an insurance product that is a candidate recommended to the subject by using an extraction model machine learned in such a way as to output a portion related to the data in the document using a set of the document and the data as an input.

According to an exemplary aspect of the present disclosure, there is an exemplary effect that it is possible to facilitate work of searching for an insurance product that satisfies a desired condition by the subject.

### BRIEF DESCRIPTION OF THE DRAWINGS

FIG. 1 is a block diagram illustrating a configuration of an information processing apparatus according to the present disclosure;

FIG. 2 is a flowchart illustrating a flow of a support method according to the present disclosure;

FIG. 3 is a block diagram illustrating a configuration of another information processing apparatus according to the present disclosure;

FIG. 4 is a diagram illustrating an extraction example of a related description;

FIG. 5 is a diagram illustrating an example of determining whether an insurance product associated with a related description satisfies a desired condition indicated in condition information;

FIG. 6 is a diagram illustrating an example of a user interface (UI) screen that receives a correction instruction;

FIG. 7 is a diagram illustrating an example of a UI screen that receives addition and change of a desired condition;

FIG. 8 is a diagram illustrating an example of a UI screen that receives an input of an explanatory sentence of history information;

FIG. 9 is a flowchart illustrating a flow of processing executed by the information processing apparatus illustrated in FIG. 3;

FIG. 10 is a block diagram illustrating a configuration of an information processing apparatus according to a reference example; and

FIG. 11 is a block diagram illustrating a configuration of a computer that functions as an information processing apparatus according to the present disclosure.

### EXAMPLE EMBODIMENT

Hereinafter, example embodiments of the present invention will be described. However, the present invention is not limited to the exemplary example embodiments to be described below, and various modifications can be made within the scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extensions of the present invention. That is, example embodiments that do not achieve the effects mentioned in the following exemplary example embodiments can also be included in the scope of the present invention.

### First Exemplary Example Embodiment

A first exemplary example embodiment that is an example of an example embodiment of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in the drawings referred to for describing the present exemplary example embodiment can also be adopted in the other exemplary example embodiments included in the present disclosure within a range in which no particular technical problem occurs.

### (Configuration of Information Processing Apparatus 1)

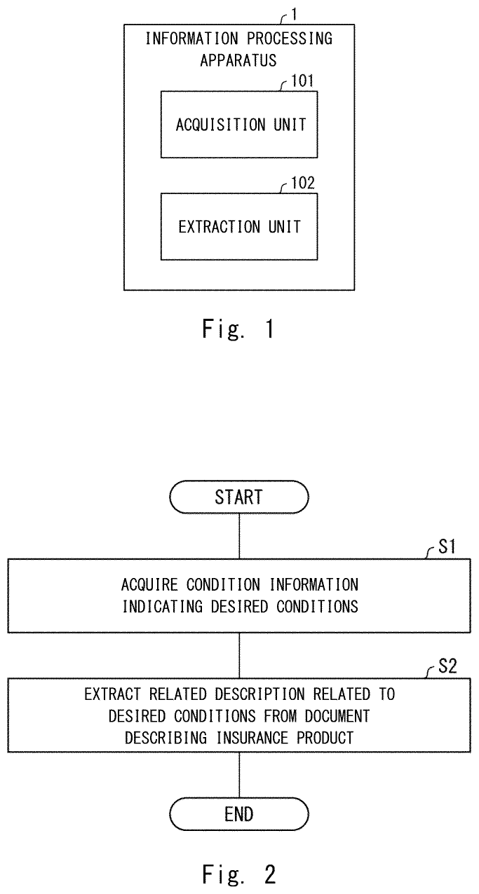

A configuration of an information processing apparatus 1 according to the present exemplary example embodiment will be described with reference to FIG. 1. FIG. 1 is a block diagram illustrating a configuration of the information processing apparatus 1. As illustrated in FIG. 1, the information processing apparatus 1 includes an acquisition unit 101 and an extraction unit 102.

The acquisition unit 101 acquires condition information indicating a desired condition of the subject for the insurance. The “condition information” may indicate at least one desired condition. For example, the desired condition may indicate a compensation content desired by the subject, an upper limit amount of the premium paid by the subject, and the like. The “insurance” described above may be any insurance, and for example, may be an insurance relating to the life or health of an insured person such as a life insurance, an endowment insurance, or a medical insurance, or may be an insurance relating to owned property such as an automobile insurance or a fire insurance. For example, the acquisition unit 101 may acquire text data in which desired conditions are listed by the subject as the condition information.

For example, the acquisition unit 101 may acquire history information regarding a desired condition of the subject for the insurance as the condition information. For example, the acquisition unit 101 may acquire history information indicating, in addition to a sick/injured history (which may include a current health condition) of the subject, whether the subject regularly visits a hospital, a history of prescribed medicines, a result of a health checkup, a result of an examination by a doctor, a result of a medical examination, a history of receiving welfare benefits, and the like. It can be said that such history information indicates a desire of the subject to desire recommendation of an insurance that can be subscribed even in the mental and physical state indicated in the information. For example, the acquisition unit 101 may acquire history information indicating an insurance contracted in the past or purchase history information of a product or a service reflecting a hobby or a taste of the subject as the condition information, or may acquire attribute information such as a name and a date of birth of the subject as the condition information.

Any method of acquiring the condition information is applicable. The acquisition unit 101 may acquire a plurality of types of condition information. For example, the acquisition unit 101 may acquire both text data input by the subject and history information recorded in a predetermined database (for example, a database in which various types of information regarding medical insurance and the like are recorded in association with individual identification information allocated to each of the people) as the condition information.

The extraction unit 102 extracts a related description related to the desired condition indicated in the condition information acquired by the acquisition unit 101 from a document describing an insurance product that is a candidate recommended to the subject, using an extraction model machine learned in such a way as to output a portion related to the data in the document using a set of the document and the data as an input.

The “insurance product” described above may be any insurance product sold by an insurance company or the like. The insurance product may be a product of only the main contract, or may be a product including a combination of the main contract and the special agreement.

The above “extraction model” may be any model that can be used to extract the related description related to the desired condition from the document describing the insurance product. For example, a model that divides a document describing an insurance product into texts of a predetermined unit (for example, for each sentence or for each desired condition), calculates a score indicating similarity (which can also be referred to as relevance) of the content with the desired condition for each of the texts obtained by the division, and outputs a text of which the calculated score is equal to or more than a predetermined threshold can be used as the extraction model. Such a model can be generated, for example, by machine learning using training data in which the score in a set of text and data is associated as ground truth data with respect to the set of text and data. The data paired with the text is typically text data, but it is also possible to use data in another format such as image data.

The “extraction model” described above may be a general-purpose model that can be used for applications other than the extraction of the related description in connection, or may be a model obtained by fine-tuning a general-purpose model for the extraction described in connection. The extraction model may be included in the information processing apparatus 1 or may be included in another apparatus. In the latter case, the extraction unit 102 uses the extraction model via another device including the extraction model.

The “document describing an insurance product” may be a document describing information regarding a target insurance. For example, an application form, a Q & A collection, an instruction manual, a web page introducing the insurance, a review by a policyholder of the insurance, a contract term, or the like of the insurance may be used as a document describing an insurance product. A description of a plurality of insurance products may be described in one document. In that case, the extraction unit 102 can extract the related description from the description portion for each of the plurality of insurance products. One document may describe one insurance product. In this case, the extraction unit 102 may extract the related description from each of the plurality of documents.

As described above, the information processing apparatus 1 according to the present exemplary example embodiment employs a configuration including: the acquisition unit 101 that acquires condition information indicating a desired condition of the subject for insurance; and the extraction unit 102 that extracts a related description related to the desired condition from a document describing an insurance product that is a candidate recommended to the subject, using an extraction model machine learned in such a way as to output a portion related to data in the document by using a set of document and data as an input.

Since the related description extracted as described above is related to the desired condition, it can be said that the related description is a part having high importance in searching for an insurance product satisfying the desired condition among documents describing the insurance product. Therefore, according to the information processing apparatus 1, it is possible to obtain an effect that it is possible to facilitate work of searching for an insurance product that satisfies the desired condition by the subject. According to the information processing apparatus 1, it is also possible to support decision making in a case where the subject selects an insurance product.

Any method of using the extracted related description in facilitating the work of searching for an insurance product is applicable. For example, the information processing apparatus 1 may present the extracted related description to the subject as reference information in a case of searching for an insurance product. For example, as described in a second exemplary example embodiment to be described later, an insurance product that satisfies a desired condition of the subject may be specified and presented using the extracted related description.

### (Support Program)

The functions of the information processing apparatus 1 described above can also be achieved by a program. A support program according to the present exemplary example embodiment is a support program for supporting an insurance search causing a computer to function as acquisition means for acquiring condition information indicating a desired condition of the subject for insurance, and extraction means for extracting a related description related to the desired condition from a document describing an insurance product that is a candidate recommended to the subject by using an extraction model machine learned in such a way as to output a portion related to the data in the document using a set of the document and the data as an input. According to this support program, it is possible to obtain an effect of facilitating work of searching for an insurance product that satisfies a desired condition by the subject.

### (Flow of Support Method)

A flow of a support method according to the present exemplary example embodiment will be described with reference to FIG. 2. FIG. 2 is a flowchart illustrating a flow of the support method. An executing entity of each step in this support method may be a processor included in the information processing apparatus 1, may be a processor included in another apparatus, or an executing entity of each step may be a processor provided in each of different apparatuses.

In S1 (acquisition processing), at least one processor acquires condition information indicating a desired condition of the subject for the insurance.

In S2 (extraction processing), at least one processor extracts a related description related to a desired condition indicated in the condition information acquired in S1 from a document describing an insurance product that is a candidate recommended to the subject by using an extraction model machine learned in such a way as to output a portion related to the data in the document using a set of the document and the data as an input.

As described above, the support method according to the present exemplary example embodiment is a support method for supporting insurance search, and employs a configuration in which at least one processor executes: acquisition processing of acquiring condition information indicating a desired condition of the subject for insurance; and extraction processing of extracting a related description related to the desired condition from a document described for an insurance product that is a candidate recommended to the subject, using an extraction model machine learned in such a way as to output a portion related to data in the document by using a set of document and data as an input. According to this support method, it is possible to obtain an effect of facilitating work of searching for an insurance product that satisfies a desired condition by the subject.

### Second Exemplary Example Embodiment

A second exemplary example embodiment that is an example embodiment of the present invention will be described in detail with reference to the drawings. Components having the same functions as the components described in the above-described exemplary example embodiment will be denoted by the same reference numerals, and the description thereof will be appropriately omitted. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Configuration of Information Processing Apparatus 1A)

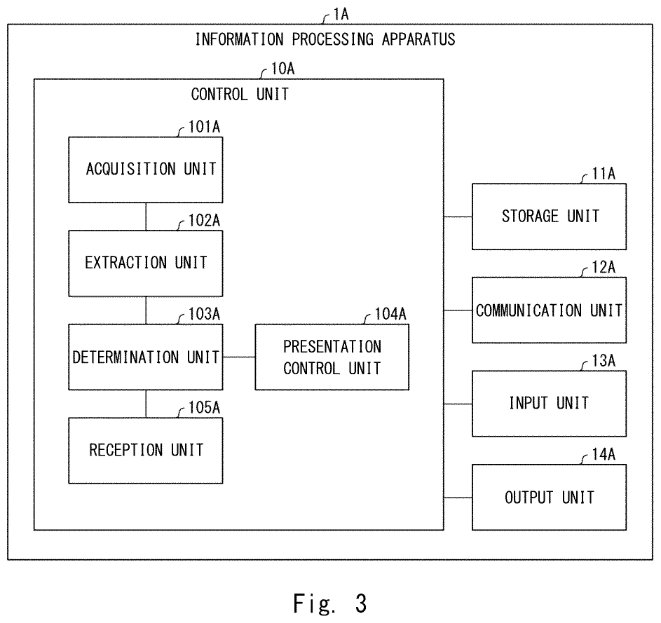

A configuration of an information processing apparatus 1A according to the present exemplary example embodiment will be described with reference to FIG. 3. FIG. 3 is a block diagram illustrating the configuration of the information processing apparatus 1A. The information processing apparatus 1A is an apparatus having a function of supporting insurance search. The information processing apparatus 1A may be a local apparatus used by individual users, or may be a server that provides a support service for insurance search to a plurality of users.

As illustrated, the information processing apparatus 1A includes a control unit 10A that integrally controls units of the information processing apparatus 1A, and a storage unit 11A that stores various types of data to be used by the information processing apparatus 1A. The information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. Then, the control unit 10A includes an acquisition unit 101A, an extraction unit 102A, a determination unit 103A, a presentation control unit 104A, and a reception unit 105A.

The acquisition unit 101A acquires condition information indicating a desired condition of the subject for the insurance, similarly to the acquisition unit 101 of the first exemplary example embodiment. Hereinafter, an example in which the subject inputs condition information in a text format in which the desired condition of the subject is described in a natural language to the information processing apparatus 1A, and the acquisition unit 101A acquires the input condition information will be mainly described.

Similarly to the extraction unit 102 of the first exemplary example embodiment, the extraction unit 102A extracts a related description related to the desired condition from a document describing an insurance product that is a candidate recommended to the subject by using an extraction model machine learned in such a way as to output a portion related to the data in the document using a set of the document and the data as an input. Hereinafter, the extraction model used by the extraction unit 102A is referred to as an extraction model M1.

The determination unit 103A determines whether the insurance product described by the related description extracted by the extraction unit 102A satisfies the desired condition of the subject using a language model that has machine learned a natural language. Here, machine learning on natural language more specifically means learning of the arrangement of components (words and the like) in a sentence in a natural language and the arrangement of sentences in a text. Examples of the language model trained on natural language include bidirectional encoder representations from transformers (BERT), Robustly optimized BERT approach (RoBERTa), efficiently learning an encoder that classifies token replacements accurately (ELECTRA), and the like. Hereinafter, the language model used by the determination unit 103A is referred to as a language model M2.

In the present exemplary example embodiment, an example in which the language model M2 is a model that accepts an input of a prompt in a text format described in a natural language and outputs an answer in the natural language will be described. However, the language model M2 may be a model capable of receiving input of data in a format other than text data such as an image.

The language model M2 may be a general-purpose language model that can be used for applications other than the inference of whether the insurance product satisfies the desired condition, or may be obtained by fine-tuning the general-purpose language model for the inference of whether the insurance product satisfies the desired condition. The language model M2 may be included in the information processing apparatus 1A or may be included in another apparatus. In the latter case, the determination unit 103A uses the language model M2 via another device including the language model M2.

The extraction of the related description by the extraction unit 102A is not an essential premise in the determination by the determination unit 103A. For example, the determination unit 103A may determine whether the desired condition indicated in the condition information acquired by the acquisition unit 101A is satisfied for each sentence included in the document describing the insurance product. Although the number of times of determination by the determination unit 103A is increased as compared with the case of extracting the related description, it is possible to recommend an insurance product that satisfies the desired condition of the subject even in a case of adopting such processing.

The presentation control unit 104A presents various types of information regarding support of insurance search. For example, the presentation control unit 104A presents the insurance product determined by the determination unit 103A to satisfy the desired condition to the subject as a recommended insurance product. For example, the presentation control unit 104A presents the inference result output by the language model M2. Although details will be described later, the presentation control unit 104A may present the inference result together with the basis of the inference. Any method of presenting the information is applicable. For example, the presentation control unit 104A may present information by causing the output unit 14A to output the information, or may present information by causing another device to output the information via the communication unit 12A. The information can be presented in any form such as display, printing, voice, or a combination thereof.

The reception unit 105A receives various instructions regarding support of insurance search. For example, the reception unit 105A receives a correction instruction for a result of inference by the language model M2. Any method of receiving the instruction is applicable. For example, the reception unit 105A may receive an instruction input via the input unit 13A, or may receive an instruction from another device via the communication unit 12A.

As described above, the information processing apparatus 1A includes: the acquisition unit 101A that acquires condition information indicating a desired condition of the subject for the insurance; and the extraction unit 102A that extracts a related description related to the desired condition from a document describing an insurance product that is a candidate recommended to the subject by using the extraction model M1 machine learned in such a way as to output a portion related to data in the document using a set of the document and the data as an input. Therefore, according to the information processing apparatus 1A, similarly to the information processing apparatus 1, it is possible to obtain an effect that it is possible to facilitate work of searching for an insurance product that satisfies a desired condition by the subject.

As described above, the information processing apparatus 1A includes: the determination unit 103A that determines whether the insurance product described by the related description extracted by the extraction unit 102A satisfies the desired condition by using the language model M2 trained by machine learning on natural language; and the presentation control unit 104A that presents the insurance product determined to satisfy the desired condition by the determination unit 103A to the subject as a recommended insurance product. As a result, in addition to the effect obtained by the information processing apparatus 1, an effect that an insurance product having a high possibility of satisfying the desired condition can be recommended to the subject can be obtained.

The determination by the determination unit 103A can be omitted. In a case where the determination by the determination unit 103A is omitted, the presentation control unit 104A may present the related description extracted by the extraction unit 102A. In this case, the subject needs to compare the presented related description with the desired condition and to determine whether to select the insurance product associated with the related description. As a result, it is possible to save the time and effort of the subject searching for the related description related to the desired condition from the document describing the insurance product and to facilitate the work of searching for the insurance product.

As described above, the information processing apparatus 1A includes the acquisition unit 101A that acquires condition information indicating a desired condition of the subject for the insurance, and the determination unit 103A that determines whether the insurance product satisfies the desired condition using the document describing the insurance product and the language model M2 trained by machine learning on natural language. According to the information processing apparatus 1A, since it is possible to obtain an objective determination result as to whether the insurance product satisfies the desired condition, it is possible to obtain an effect that it is possible to facilitate work of searching for the insurance product that satisfies the desired condition of the subject.

### (Exemplary Extraction of Related Description)

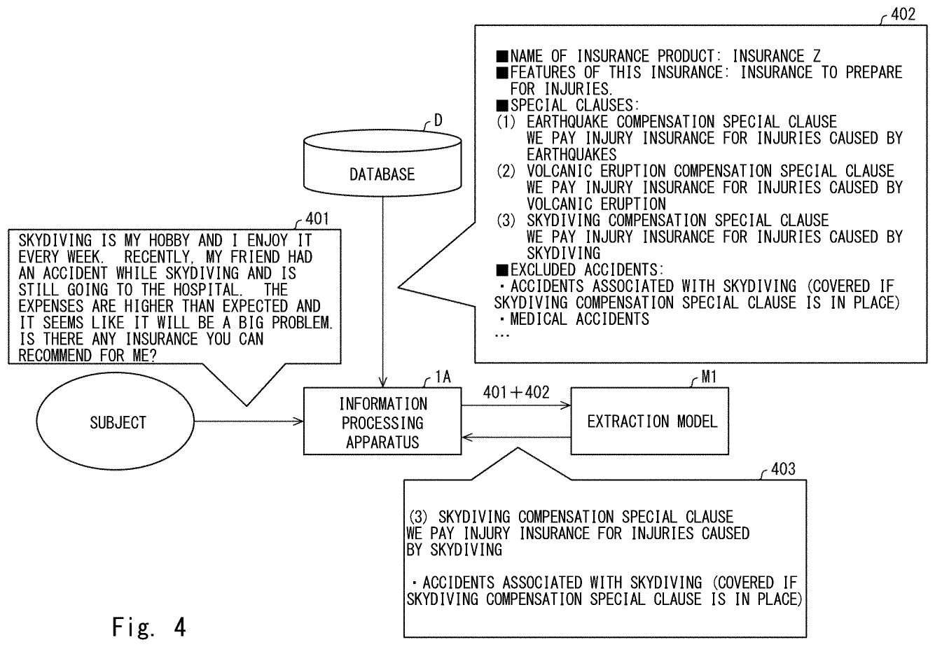

An extraction example of the related description by the information processing apparatus 1A will be described with reference to FIG. 4. FIG. 4 is a diagram illustrating an extraction example of a related description. In the example of FIG. 4, the subject who is considering purchase of the insurance inputs the condition information 401 to the information processing apparatus 1A. The input condition information 401 is acquired by the acquisition unit 101A included in the information processing apparatus 1A.

The condition information 401 indicates a desired condition of the subject for the insurance, and is specifically a text describing a risk that the subject wants to cover with the insurance in a natural language. Since the extraction unit 102A extracts related descriptions using the extraction model M1, it is possible to handle the condition information 401 freely described by the subject in natural language. Although only one desired condition is illustrated in the condition information 401 illustrated in FIG. 4, it is also possible to input condition information listing a plurality of desired conditions.

For example, the subject may input the condition information 401 via the input unit 13A, or may input the condition information 401 via the communication unit 12A using his/her own terminal device or the like. The subject may input the condition information 401 as text data or as voice data. In the latter case, the acquisition unit 101A can acquire the condition information 401 in a text format by causing the information processing apparatus 1A or another speech recognition apparatus to perform speech recognition on the input speech data.

In the example of FIG. 4, the information processing apparatus 1A (more specifically, the acquisition unit 101A) acquires, from the database D, a document 402 describing an insurance product that is a candidate recommended to the subject. In a case where the document 402 is acquired from the database D, documents describing various kinds of insurance may be recorded in the database D. As a result, the acquisition unit 101A can acquire the document 402 describing the insurance product that is a candidate recommended to the subject from the database D. Although FIG. 4 illustrates an example of acquiring the document 402 describing one insurance product, documents describing a plurality of insurance products may be acquired, or a plurality of documents describing one or a plurality of insurance products may be acquired. Any method of acquiring the document 402 is applicable, and is not limited to the above example. For example, the subject may input the document 402 to the information processing apparatus 1A together with the condition information 401, or the document 402 may be stored in the information processing apparatus 1A in advance.

Next, the information processing apparatus 1A (more specifically, the extraction unit 102A) inputs the condition information 401 and the document 402 acquired by the acquisition unit 101A as described above to the extraction model M1. As a result, the related description 403 is output from the extraction model M1.

The related description 403 is a description of a portion related to a desired condition that satisfies the desired condition indicated by the condition information 401 in the description of the insurance product described in the document 402. Specifically, the related description 403 is a description of a sky-diving compensation special agreement related to the desired condition of the insurance recommended to the subject who is interested in sky-diving indicated in the condition information 401.

Although details will be described below, the determination unit 103A determines whether the insurance product associated with the related description 403 extracted as described above (that is, the insurance product described by the related description 403) satisfies the desired condition indicated in the condition information 401. As described above, the presentation control unit 104A may present the extracted related description 403 to the subject. In this case, the presentation control unit 104A may cut out and present the portion of the related description 403 from the document 402, or may present the document 402 in which the portion of the related description 403 is highlighted. The highlight may be performed in a mode in which the highlighted portion and the non-highlighted portion can be identified. For example, the presentation control unit 104A may highlight a portion of the related description 403 in the document 402 by changing the background color of the highlighted portion, changing the character font of the highlighted portion, or the like.

### (Example of Determination as to Whether Insurance Product Satisfies Desired Condition)

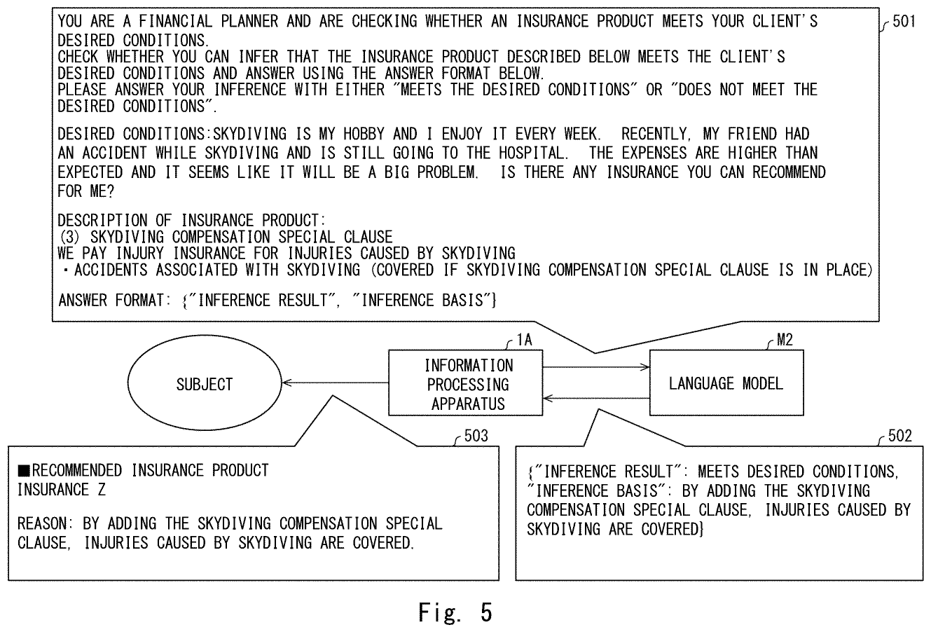

FIG. 5 is a diagram illustrating an example of determining whether the insurance product associated with the related description 403 satisfies the desired condition indicated in the condition information 401. As described above, this determination is performed by the determination unit 103A. A language model M2 is used for this determination. Therefore, the determination unit 103A generates a prompt describing the content of the instruction for the language model M2 and inputs the prompt to the language model M2.

In the example of FIG. 5, the information processing apparatus 1A (more specifically, the determination unit 103A) inputs a prompt 501 to the language model M2. The prompt 501 includes the related description 403 illustrated in FIG. 4 and the condition information 401 illustrated in FIG. 4, and instructs to infer the relationship between the desired condition indicated in the condition information 401 and the related description 403.

More specifically, the condition information 401 is described in the item “desired conditions” in the prompt 501. The related description 403 is described in the item of “description of insurance product” in the prompt 501. Further, the prompt 501 includes a sentence “You are a financial planner and are checking whether an insurance product meets your client's desired conditions.”. It is not essential to include such a sentence, but the inference accuracy can be expected to be improved by including such a sentence.

The prompt 501 is content instructing to check whether it can be inferred that the insurance product satisfies the desired condition of the client. The expression in the prompt can be appropriately changed within a range in which a desired inference result can be obtained. For example, the determination unit 103A may generate a prompt having a different expression of the inference instruction according to a desired condition, a type of insurance, a language model to be used, and the like.

The prompt 501 includes an “answer format” and has contents instructing to answer in this answer format. In this way, by specifying the answer format, it is possible to obtain an inference result in a desired format. This answer format includes an item “inference basis”. By including such items, it is possible to cause the language model M2 to output the inference result and the grounds of the inference. The instruction to output the grounds of inference may be made by including a text such as “Please answer the grounds together with the inference result” in the prompt, for example.

The prompt 501 may include a text specifying an output condition. For example, a text such as “In a case where a plurality of desired conditions are listed, it is necessary to infer whether the insurance product satisfies the desired conditions for all the desired conditions.” or “The number of elements included in the answer format needs to match the number of desired conditions.” may be included in the prompt 501. This makes it possible to enhance the inference accuracy of the language model M2.

In the prompt 501, contents other than the “desired conditions” and the “description of insurance product” are fixed. Therefore, a portion other than the contents of the “desired conditions” and the “description of insurance product” in the prompt 501 may be stored in the storage unit 11A or the like as a fixed template. As a result, the determination unit 103A can generate the prompt 501 by inputting the condition information 401 acquired by the acquisition unit 101A and the related description 403 extracted by the extraction unit 102A to the template.

The inference result 502 illustrated in FIG. 5 illustrates an example of an inference result obtained by inputting the prompt 501 to the language model M2. The inference result 502 indicates the result of inferring the relationship between the desired condition and the related description 403 in the form of the answer format indicated in the prompt 501. Specifically, the inference result 502 indicates an inference result indicating that the insurance product associated with the related description 403 “satisfies the desired condition”. In the inference result 502, the basis of the inference is indicated together with the inference result.

As described above, the condition information 401 may indicate a plurality of desired conditions. In that case, a prompt may be used to instruct to infer whether the related description 403 satisfies the desired condition for each of the plurality of desired conditions. The extraction unit 102A may extract a plurality of related descriptions. In that case, a prompt may be used to instruct to infer whether the related description satisfies the desired condition for each of the plurality of related descriptions.

In what form the inference result is output can be specified by a prompt. For example, the determination unit 103A may generate a prompt for instructing to answer with three choices of satisfying the desired condition, being neutral, and not satisfying the desired condition. In this case, in a case where an answer indicating that the insurance product associated with a certain related description satisfies a certain desired condition is output, the determination unit 103A may determine that the insurance product associated with the related description satisfies the desired condition. What kind of processing is to be performed in a case where a neutral response is output may be determined in advance. For example, in a case where an answer of neutrality is output in response to a prompt asking whether an insurance product associated with a certain related description satisfies a certain desired condition, the presentation control unit 104A may present a combination of the related description and the desired condition to the subject and cause the subject to input whether the insurance product associated with the related description satisfies the desired condition. For example, the determination unit 103A may generate a prompt for instructing to output a numerical value (for example, a numerical value of 0 to 1) indicating the degree of possibility that the desired condition is satisfied. In this case, in a case where a numerical value output for a combination of a certain desired condition and a certain related description is equal to or more than a predetermined threshold value, the determination unit 103A may determine that the insurance product associated with the related description satisfies the desired condition.

FIG. 5 illustrates a screen example 503 for presenting the inference result 502. In the screen example 503, an insurance product associated with the related description 403 from which the inference result indicating that the desired condition is satisfied is obtained is illustrated as a recommended insurance product, and the basis of the inference included in the inference result 502 is also illustrated. The presentation control unit 104A can generate and present a screen such as the screen example 503 using various types of information indicated in the inference result 502. In this manner, the presentation control unit 104A may present the insurance product determined to satisfy the desired condition by the determination unit 103A to the subject as a recommended insurance product. As described above, the presentation control unit 104A may present the inference basis output by the language model M2 to the subject as a determination material for determining whether the inference result is appropriate.

In a case where the output unit 14A has a function of displaying and outputting an image, the presentation control unit 104A may cause the output unit 14A to display a screen such as the screen example 503. The presentation control unit 104A may display a screen such as the screen example 503 on a display device (for example, a display device included in a terminal device used by the subject) outside the information processing apparatus 1A via the communication unit 12A.

As described above, the determination unit 103A may generate the prompt 501 that includes the related description and the desired condition and instructs to infer the relationship between the related description and the desired condition, and determine whether the insurance product described by the related description satisfies the desired condition based on the inference result 502 that is an output obtained by inputting the generated prompt 501 to the language model M2. This makes it possible to appropriately determine whether the insurance product described by the related description satisfies the desired condition.

### (Presentation and Re-Inference of Inference Result)

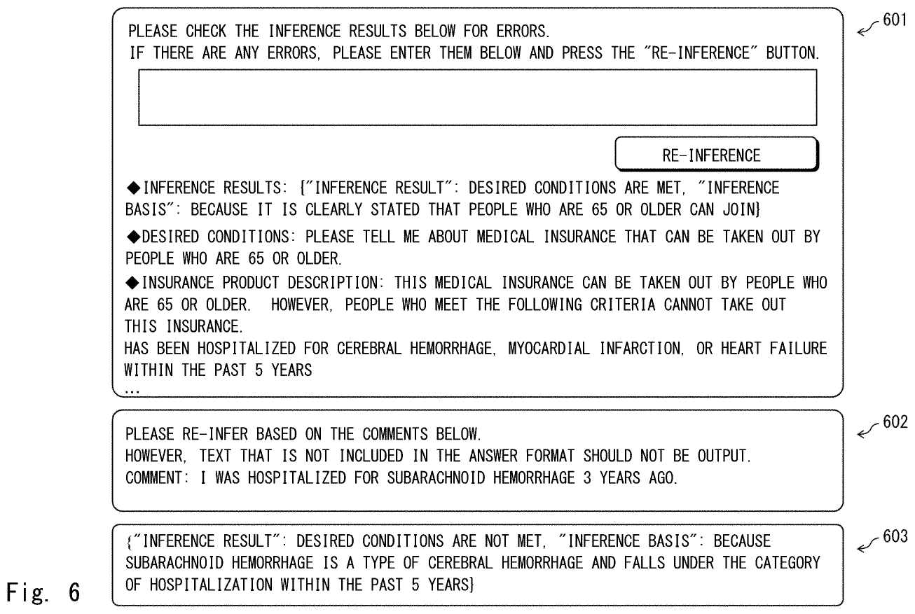

The reception unit 105A may receive a correction instruction for a result of inference by the language model M2. This will be described with reference to FIG. 6. FIG. 6 is a diagram illustrating an example of a UI screen that receives a correction instruction. FIG. 6 also illustrates a prompt 602 for instructing re-inference based on a correction instruction and a re-inference result 603 obtained by inputting the prompt 602 to the language model M2, in addition to the screen example 601 which is an example of a UI screen for receiving a correction instruction.

In the screen example 601, the inference result of the language model M2, the desired condition to be inferred, and the description of the insurance product (related description extracted by the extraction unit 102A) are illustrated. The screen example 601 illustrates a text that prompts the user to confirm whether there is an error in the inference result and requests the user to input the content of the error and instruct the re-inference if there is an error. In the screen example 601, a text box for inputting the correction content and a button (software key) for instructing re-inference are also displayed.

The presentation control unit 104A can cause the subject to confirm the inference result by presenting the UI screen such as the screen example 601 to the subject. The reception unit 105A can also receive correction for the inference result via a UI screen such as the screen example 601.

In the screen example 601, in a case where a correction content is input to a text box and a button for instructing re-inference is operated, the reception unit 105A receives the input correction content as a correction instruction. For example, the reception unit 105A may receive a correction instruction in which the reason why the inference result is an error is described in a natural language. For example, the reception unit 105A may receive a correction instruction describing, in natural language, whether an insurance product associated with a related description that is a target of inference satisfies a desired condition.

Then, the determination unit 103A redetermines whether the insurance product associated with the related description satisfies the desired condition based on the correction instruction received by the reception unit 105. For example, the determination unit 103A may generate the prompt 602 illustrated in FIG. 6 and input the prompt to the language model M2, and may redetermine whether the insurance product associated with the related description satisfies the desired condition based on the re-inference result 603 output from the language model M2.

The prompt 602 includes the text of the correction instruction received by the reception unit 105, and is a prompt to instruct to infer the relationship between the related description (specifically, the description of the insurance product) and the desired condition based on the correction instruction. The prompt 602 includes a text “However, text that is not included in the answer format should not be output.”. In this manner, the prompt for instructing re-inference may also include a text specifying an output condition. As a result, it is possible to prevent unnecessary content (for example, texts such as “Sorry. I will output again.” and “Contents have been updated.”) from being output from the language model M2, and to prevent a problem from occurring in recommendation of an insurance product or the like. The prompt 602 can also be generated using a predetermined template similarly to the prompt 501 illustrated in FIG. 5. The prompt 602 may also describe a desired condition, a related description, an answer format, and the like, similarly to the prompt 501.

In the re-inference result 603 illustrated in FIG. 6, the inference result of the relationship between the desired condition and the related description (specifically, the description of the insurance product) is changed from that illustrated on the UI screen 601 by reflecting the “comment”indicated in the prompt 602, that is, the content of the correction instruction. Specifically, in the re-inference result 603, the inference result as to whether the related description of “This medical insurance can be taken out by people who are 65 or older. However, people who meet the following criteria cannot take out this insurance. has been hospitalized for cerebral hemorrhage, myocardial infarction, or heart failure within 5 years . . . ” satisfies the desired condition of “Please tell me about medical insurance that can be taken out by people who are 65 or older.” is changed to “desired conditions are not met”. The inference basis has been changed to a sentence “Subarachnoid hemorrhage is a type of cerebral hemorrhage and falls under the category of hospitalization within the past 5 years”. As described above, the re-inference is performed using the prompt 602 including the sentence in the natural language received as the correction instruction, in such a way that the re-inference result 603 reflecting the content of the correction instruction can be output.

As described above, the determination unit 103A may generate a prompt (for example, the prompt 501 in FIG. 5) instructing to output the basis of the inference together with the inference result of the relationship between the related description and the desired condition. Then, the presentation control unit 104A may present the inference result output by the language model M2 together with the basis. As a result, in addition to the effect obtained by the information processing apparatus 1, it is possible to obtain an effect that the appropriateness/inappropriateness of the inference result of the language model M2 can be examined using the basis thereof as a determination material. Instead of the inference result output by the language model M2, the presentation control unit 104A may present the determination result of the determination unit 103A or the insurance product determined by the determination unit 103A to satisfy the desired condition (that is, the insurance product recommended to the subject) together with the above described grounds.

As described above, the information processing apparatus 1A includes the reception unit 105A that receives a correction instruction for the inference result. Then, the determination unit 103A redetermines whether the insurance product described by the related description satisfies the desired condition based on the correction instruction received by the reception unit 105. As a result, in addition to the effect obtained by the information processing apparatus 1, an effect that an error in the inference result can be corrected and a valid insurance product can be recommended can be obtained.

As described above, the reception unit 105A may receive a correction instruction representing a correction content in a natural language. In this case, the determination unit 103A generates a prompt (for example, the prompt 602 in FIG. 6) that includes the correction instruction received by the reception unit 105A and instructs to infer the relationship between the related description and the desired condition based on the correction instruction, and redetermines whether the insurance product described by the related description satisfies the desired condition based on the output obtained by inputting the generated prompt to the language model M2. As a result, in addition to the effect obtained by the information processing apparatus 1, it is possible to obtain an effect that appropriate redetermination can be performed by considering the intention of the correction instruction.

As an example in which the intention of the correction instruction can be grasped, there is absorption of notation distortion. For example, instead of the comment “I was hospitalized for subarachnoid hemorrhage 3 teas ago.” as in the example of FIG. 6, even if a correction instruction such as “He is hospitalized with cerebral hemorrhage” or “Since he is hospitalized due to subarachnoid hemorrhage, he may not be able to enroll.” or is input, it is possible to set the result of the re-inference as “not satisfying the desired condition”.

In a case where a correction instruction representing a correction content in a natural language is received, there is also an advantage that the content of the correction instruction can be reflected in other inferences. For example, it is assumed that, in response to an inference result that a related description of “I will compensate for an accident caused by a bicycle” satisfies a desired condition of “I like cycling”, a correction instruction of “no compensation for a bicycle is necessary since I have a separate insurance for bicycle” is input. In this case, the determination unit 103A can not only correct the inference result to “not satisfying the desired condition”, but also update another inference result based on the fact that the subject has already subscribed to the insurance for the bicycle.

The correction instruction is not necessarily input in a natural language. For example, the presentation control unit 104A may present an option for selecting appropriateness/inappropriateness of the inference content, and if an option indicating that the inference content is not appropriate is selected, the reception unit 105A may notify the determination unit 103A of this fact. In this case, the determination unit 103A that has received this notification changes the determination result for the target related description. That is, in a case where an input indicating that the inference content is not appropriate for the inference result of “the desired condition is satisfied” for a certain related description is received, the determination unit 103A changes the determination result for the related description to “the desired condition is not satisfied”. Similarly, in a case where an input indicating that the inference content is not appropriate has been received for the inference result of “not satisfying the desired condition” for a certain related description, the determination unit 103A changes the determination result for the related description to “satisfying the desired condition”.

### (Reuse of Correction Instruction)

The content of the correction instruction as described above may be recorded in the storage unit 11A or an external database or the like and used for the subsequent inference. For example, a comment of a correction instruction of “no compensation for the bicycle is necessary because the bicycle has another insurance” may be recorded, and this comment may be used for inference about other related descriptions. As a result, the determination unit 103A can perform inference based on the fact that the subject has already subscribed to the insurance for the bicycle in the subsequent inference. If the content of the correction instruction is related to a person other than the specific subject, the content of the correction instruction can be used for inference for other subjects.

The presentation control unit 104A may present the recorded content of the correction instruction to the subject, and the reception unit 105A may receive correction, deletion, addition, or the like of the content of the correction instruction. As a result, the content of the correction instruction according to the intention of the subject can be reflected in the subsequent inference without relearning the language model M2 or the like. The correction instruction may be reused by including the correction instruction in the prompt as in the case where the correction instruction is used for the first time. That is, the determination unit 103A may generate a prompt including the recorded correction instruction and instructing to infer the relationship between the related description and the desired condition based on the correction instruction, input the generated prompt to the language model M2, and output an inference result indicating whether the related description satisfies the desired condition.

### (Repetition of Inference)

Since the language model M2 is a probabilistic model, inference results in a plurality of inferences can be different from each other even in a case where exactly the same prompt is input. In particular, it is known that there is a tendency that an inference result different from the fact is hardly repeatedly output. Therefore, the determination unit 103A may perform processing of inputting a prompt to the language model M2 and outputting the inference result a plurality of times. In this case, the determination unit 103A may determine that the desired condition is not satisfied for the insurance product associated with the related description having a large variation in the inference result. For example, the determination unit 103A may calculate a score (for example, a ratio of inference results having different contents from other inference results to all the inference results) indicating the magnitude of the variation in the inference result, and determine that the desired condition is not satisfied for the insurance product associated with the related description in which the calculated score exceeds a predetermined threshold.

### (Addition and Change of Desired Condition)

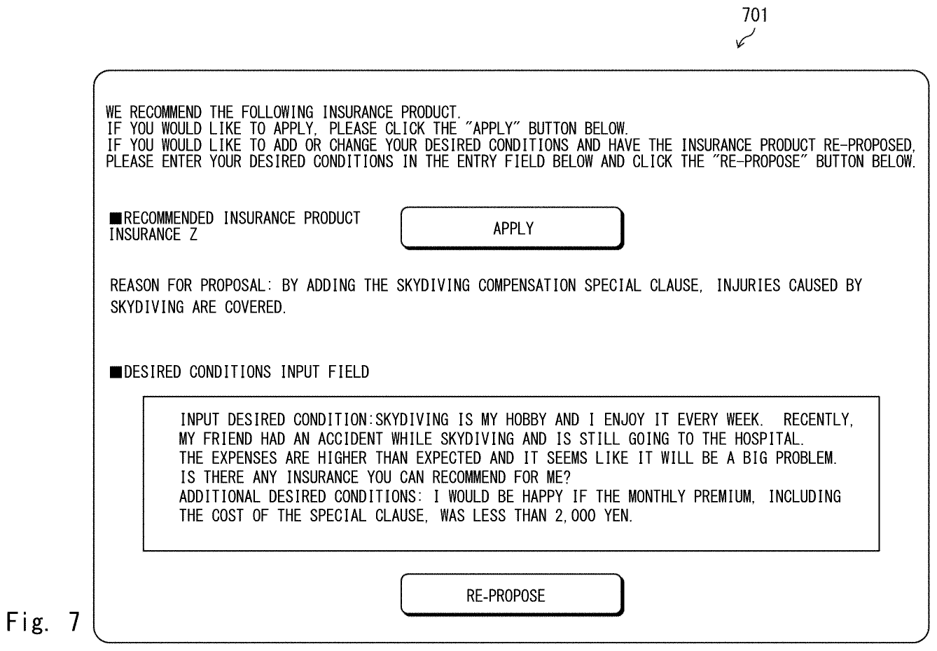

The information processing apparatus 1A may receive addition or change of a desired condition. This will be described with reference to FIG. 7. FIG. 7 is a diagram illustrating an example of a UI screen that accepts addition and change of a desired condition. In a screen example 701 illustrated in FIG. 7, a recommended insurance product, that is, an insurance product determined by the determination unit 103A to satisfy the desired condition, and a proposal reason of the insurance product are illustrated. As described above, the reason for the proposal is the basis of the inference as to whether the insurance product associated with the related description output by the language model M2 satisfies the desired condition.

In the screen example 701, a button (software key) for proceeding with application for a contract of the recommended insurance product is displayed. By displaying such a button, the contract application of the insurance product can be smoothly advanced. If the button is operated, the information processing apparatus 1A performs predetermined processing serving as some sort of support in advancing the application for the contract of the insurance product by the subject. For example, if the button is operated, the presentation control unit 104A may perform processing of presenting detailed information such as a contact details of an insurance company or an agent that sells the insurance product or a contract term of the insurance product.

In the screen example 701, a text box for inputting/correcting the desired condition and a button (software key) for instructing reproposal of the insurance product based on the desired condition input in the text box are also displayed. In the example of FIG. 7, the desired condition input by the subject is displayed in the text box, and an additional desired condition newly input by the subject is displayed. As described above, in receiving the correction/addition of the desired condition, the presentation control unit 104A may present the desired condition already input by the subject. Then, the reception unit 105A may receive a correction to the desired condition that has not been presented.

In a case where a button for instructing reproposal of the insurance product is operated in a state where the additional desired condition is input to the text box, the acquisition unit 101A acquires the input new desired condition as new condition information. Thereafter, similarly to the case where the condition information has been previously acquired, the extraction of the related description by the extraction unit 102A and the determination by the determination unit 103A are performed, and the recommended insurance product is re-presented based on the determination result.

### (Use of History Information)

The condition information acquired by the acquisition unit 101A may be condition information in which the subject inputs a desired condition for the insurance, history information regarding the desired condition of the subject for the insurance, or both of them. Here, in a case where the acquisition unit 101A acquires both the information input by the subject and the history information as the condition information, there may be a case where an item useful for recommending an optimal insurance to the subject is included in an item that is not indicated in the information input by the subject but is indicated in the history information.

Therefore, the acquisition unit 101A may perform processing of acquiring the desired condition from the information input by the subject, acquiring the desired condition from the history information, and matching these desired conditions. Then, in a case where the desired condition that is not acquired from the information input by the subject but acquired from the history information is detected by the above processing, the presentation control unit 104A may present the desired condition to the subject and prompt the subject to input whether to use the desired condition for recommendation of the insurance product. This makes it possible to complement the information input by the subject and recommend an insurance product suitable for the subject.

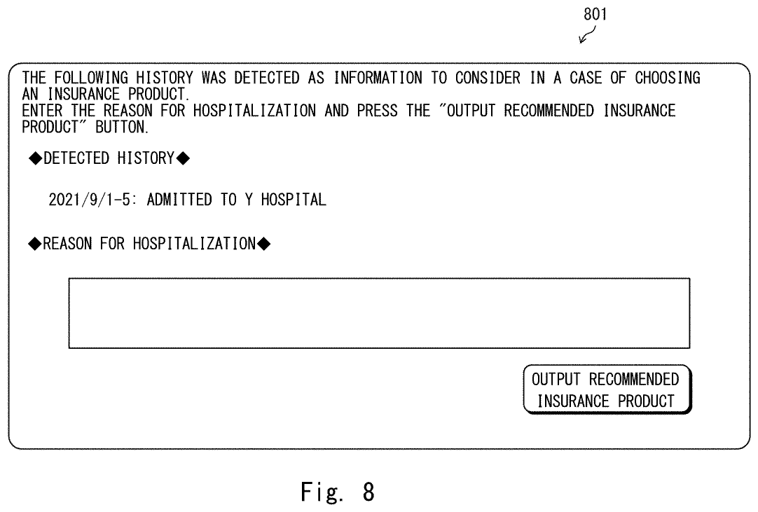

The history information acquired by the acquisition unit 101A may not include sufficient information to be used for recommendation of the insurance product. Therefore, the presentation control unit 104A may present the history information to the subject to prompt the input of an explanatory sentence describing the history information. This will be described with reference to FIG. 8.

FIG. 8 is a diagram illustrating an example of a UI screen that receives an input of an explanatory sentence of history information. In the screen example 801 illustrated in FIG. 8, a text indicating that history information to be considered in a case where an insurance product is selected has been detected is displayed, and the detected history information is displayed. Specifically, this history information indicates that the patient was admitted to the Y hospital in the period from September 1 to 5 days in 2021.

In the screen example 801, a text prompting the user to input the reason for hospitalization and press the “output recommended insurance product” button is displayed. The screen example 801 also displays a text box for inputting the reason for hospitalization and the above described “output recommended insurance product” button. The “output recommended insurance product” button is a software key for instructing to output the insurance product in consideration of the reason for input. The reception unit 105A can receive input of a reason for hospitalization, in other words, an explanatory sentence of history information, via such a UI screen.

In the screen example 801, if the reason for hospitalization is input in the text box and the “output recommended insurance product” button is operated, the extraction unit 102A extracts a related description. In this case, the extraction unit 102A extracts a related description related to the desired condition by using a set of the detected history information and the input reason for hospitalization as one desired condition. For example, in a case where the inputted reason for hospitalization is “heart failure”, the extraction unit 102A inputs a sentence “2021/9/1-5: hospitalized in Y hospital, reason for hospitalization: heart failure” to the extraction model M1 as a desired condition, and extracts a related description. Thereafter, determination is performed by the determination unit 103A, and a determination result as to whether the extracted related description satisfies the desired condition indicated in the history information, in other words, whether the insurance product purchase condition associated with the related description is satisfied is presented.

In the example of FIG. 8, the detected history information indicates a history of hospitalization. Therefore, the reception unit 105A receives an input of a reason for hospitalization. As described above, the reception unit 105A only needs to receive input of additional information associated with the content of the history information, in other words, an explanatory sentence describing the history information. For example, in a case where history information indicating a prescription history of a medicine is detected, the reception unit 105A may receive an input of an explanatory sentence for the prescribed medicine.

As described above, the information processing apparatus 1A includes the presentation control unit 104A that presents history information regarding a desired condition of the subject for insurance, and the reception unit 105A that receives input of an explanatory sentence describing the presented history information. Then, the extraction unit 102A extracts a related description related to the desired condition using the history information and the explanatory sentence as one desired condition. As a result, in addition to the effect obtained by the information processing apparatus 1, it is possible to extract an appropriate related description in consideration of the input explanatory sentence. The determination unit 103A may determine whether the insurance product satisfies the desired condition including the history information and the explanatory sentence using the language model M2. As a result, it is possible to obtain an appropriate determination result in consideration of the input explanatory sentence.

### (Flow of Processing)

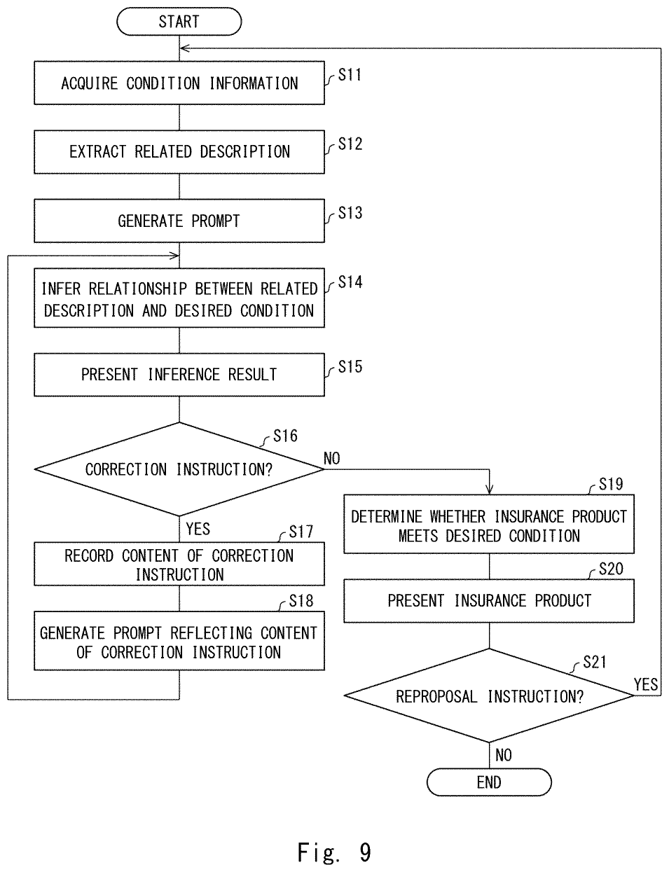

A flow of processing executed by the information processing apparatus 1A will be described with reference to FIG. 9. FIG. 9 is a flowchart illustrating a flow of processing executed by the information processing apparatus 1A. The flowchart of FIG. 9 includes each processing of the support method according to the present exemplary example embodiment.

In S11 (acquisition processing), the acquisition unit 101A acquires condition information indicating a desired condition of the subject for the insurance. For example, the acquisition unit 101A may acquire condition information input by the subject to the information processing apparatus 1A.

In S12 (extraction processing), the extraction unit 102A extracts a related description related to the desired condition indicated in the condition information acquired in S11 from the document describing the insurance product as the candidate recommended to the subject by using the extraction model M1 machine learned in such a way as to output a portion related to the data in the document using the set of document and data as an input. As described above, a plurality of desired conditions may be indicated in the condition information, and a plurality of pieces of condition information may be acquired. In this way, in a case where a plurality of desired conditions is specified, in S12, the extraction unit 102A extracts each related description related to each desired condition. The extraction unit 102A may extract a plurality of related descriptions for one desired condition. The document describing the insurance product as the candidate recommended to the subject may be input together with the condition information in S11, or may be acquired from a predetermined database as in the example of FIG. 4.

In S13, the determination unit 103A generates a prompt to be input to the language model M2. Specifically, the determination unit 103A generates a prompt that includes the related description extracted in S12 and the desired condition indicated in the condition information acquired in S11 and instructs to infer the relationship between the related description and the desired condition, in other words, whether the insurance product associated with the related description satisfies the desired condition.

In S14, the determination unit 103A inputs the prompt generated in S13 to the language model M2 to infer the relationship between the related description and the desired condition, in other words, whether the insurance product associated with the related description satisfies the desired condition. In S15, the presentation control unit 104A presents the inference result of S14 to the subject. In S16, the reception unit 105A determines whether there is a correction instruction for the inference result presented in S15. If YES is determined in S16, the processing proceeds to S17, and if NO is determined in S16, the processing proceeds to S19.

In S15, the presentation control unit 104A may present the inference result by displaying a UI screen such as the screen example 503 of FIG. 5 or the screen example 601 of FIG. 6, for example. In a case where a UI screen such as the screen example 601 is displayed, the reception unit 105A may receive a correction instruction via the UI screen. The processing of presenting the inference result may be omitted. In that case, after S14, the processing proceeds to S19.

In S17, the reception unit 105A records the content of the received correction instruction in the storage unit 11A, an external database, or the like. Any timing of recording the content of the correction instruction is applicable. For example, the reception unit 105A may record the content of the correction instruction after the determination described later is completed or after the insurance product is presented.

In S18, the determination unit 103A generates a prompt reflecting the content of the correction instruction received by the reception unit 105A, specifically, a prompt including the correction instruction and instructing to infer the relationship between the desired condition and the related description based on the correction instruction. Thereafter, the processing returns to S14, and the determination unit 103A inputs a newly generated prompt to the language model M2 to infer the relationship between the desired condition and the related description.

In S19, the determination unit 103A determines whether the insurance product described by the related description extracted in S12 satisfies the desired condition indicated in the condition information acquired in S11 based on the inference result of the language model M2. In a case where the inference by the language model M2 is performed a plurality of times, the processing of S19 is performed based on the latest inference result among the plurality of inference results.

In S20, the presentation control unit 104A presents the insurance product determined to satisfy the desired condition in S19 to the subject as a recommended insurance product. For example, the presentation control unit 104A may present the insurance product by displaying a UI screen such as a screen example 701 of FIG. 7. In a case where there is a plurality of insurance products determined to satisfy the desired condition in S19, the presentation control unit 104A may present all or some of the plurality of insurance products. For example, in a case where a plurality of desired conditions is specified, the presentation control unit 104A may preferentially present an insurance product that satisfies more desired conditions.

In S21, the reception unit 105A determines whether a reproposal instruction has been received. For example, the reception unit 105A may determine that the reproposal instruction has been received (YES in S21) in a case where the “reproposal” button is operated in the screen example 701 of FIG. 7, and may determine that the reproposal instruction has not been given (NO in S21) in a case where the “apply” button is operated. If NO is determined in S21, the process of FIG. 9 ends. In a case where NO is determined in S21, the presentation control unit 104A may end the presentation of the insurance product or may provide support (for example, presentation of more detailed information of an insurance product, presentation of an application destination, and the like) for proceeding with the application for the insurance product.

On the other hand, if YES is determined in S21, the processing returns to S11. In S11 proceeding from S21, the acquisition unit 101A acquires new condition information. For example, in a case where a UI screen such as the screen example 701 of FIG. 7 is displayed in S20, the acquisition unit 101A may acquire new condition information input via the UI screen.

### Reference Example 1

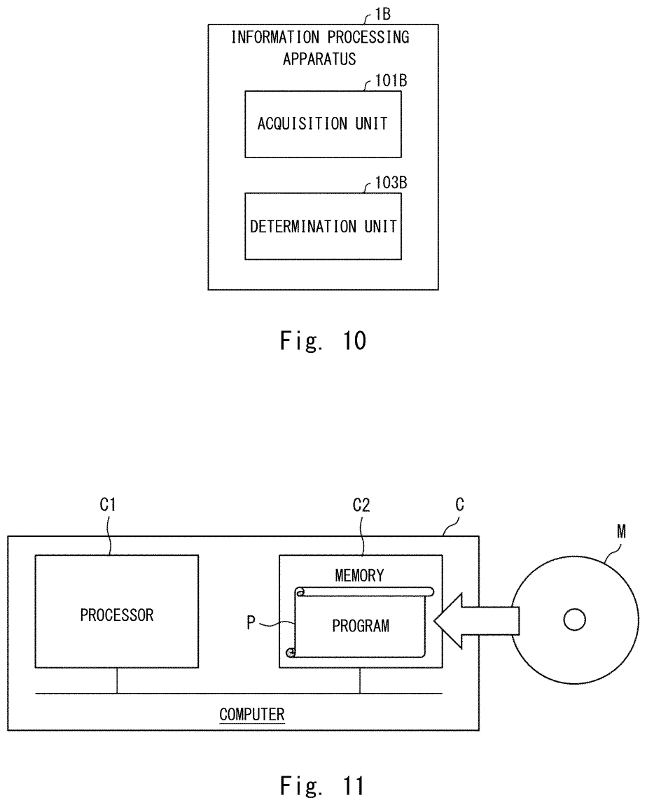

FIG. 10 is a block diagram illustrating a configuration of an information processing apparatus 1B according to the present reference example. As illustrated, the information processing apparatus 1B includes an acquisition unit 101B and a determination unit 103B.

The acquisition unit 101B acquires condition information indicating a desired condition of the subject for the insurance, similarly to the acquisition unit 101A of the second exemplary example embodiment.

Similarly to the determination unit 103A of the second exemplary example embodiment, the determination unit 103B determines whether the insurance product satisfies the desired condition indicated in the condition information acquired by the acquisition unit 101B by using the document describing the insurance product and the language model trained by machine learning on natural language.

As in the first or second exemplary example embodiment, the document may be extracted from a document describing an insurance product that is a candidate recommended to the subject by using the extraction model (that is, related description), or may not be extracted by the extraction model. For example, the determination unit 103B can cause the subject to input a part of a document (for example, a coherent part of the content such as one sentence or one paragraph) describing an insurance product that is a candidate recommended to the subject, or can extract the document by analyzing the document, and perform the above determination using the part.

As described above, the information processing apparatus 1B includes the acquisition unit 101B that acquires the condition information indicating the desired condition of the subject for the insurance, and the determination unit 103B that determines whether the insurance product satisfies the desired condition indicated in the condition information acquired by the acquisition unit 101B using the document describing the insurance product and the language model obtained by machine learning on natural language. According to the information processing apparatus 1B, it is possible to obtain an objective determination result as to whether the insurance product satisfies the desired condition. Therefore, it is possible to obtain an effect that it is possible to facilitate work of searching for an insurance product that satisfies the desired condition by the subject.

Any method of using the determination result of the determination unit 103B in facilitating the work of searching for the insurance product is applicable. For example, the presentation control unit 104A similar to that of the information processing apparatus 1A according to the second exemplary example embodiment may be provided in the information processing apparatus 1B. In this case, the presentation control unit 104A can be caused to present the determination result of the determination unit 103B or the insurance product determined by the determination unit 103B to satisfy the desired condition. As a result, the subject can consider the insurance product suitable for the subject with reference to the presented determination result or the insurance product.

### (Support Program)

The above described functions of the information processing apparatus 1B can also be achieved by a program. A support program according to the present reference example functions as: an acquisition means for acquiring condition information indicating a desired condition of the subject for insurance; and a determination means for determining whether an insurance product satisfies the desired condition by using a document describing the insurance product and a language model obtained by machine learning a natural language. According to this support program, it is possible to obtain an effect of facilitating work of searching for an insurance product that satisfies a desired condition by the subject.

### (Support Method)

A support method according to the present reference example is a support method for application of an insurance contract, in which at least one processor executes: acquisition processing of acquiring condition information indicating a desired condition of the subject for insurance; and determination processing of determining whether an insurance product satisfies the desired condition by using a document describing the insurance product and a language model obtained by machine learning a natural language. According to this support method, it is possible to obtain an effect of facilitating work of searching for an insurance product that satisfies a desired condition by the subject.

### Reference Example 2

In the above described exemplary example embodiments, the information processing apparatuses 1 and 1A have been described that acquire condition information indicating a desired condition of the subject for insurance and extract a related description related to the desired condition from a document describing an insurance product that is a candidate recommended to the subject.

In the above described reference example, the information processing apparatus 1B has been described that acquires the condition information indicating the desired condition of the subject for the insurance, and determines whether the insurance product satisfies the desired condition using the document describing the insurance product and the language model trained by machine learning on natural language.

These information processing apparatuses 1, 1A, and 1B can be used for search support for any target in addition to support for insurance search. For example, the information processing apparatuses 1, 1A, and 1B can be used in a case of searching for products or services other than insurance products.

At this time, the subject inputs condition information indicating a desired condition for a desired product or service to the information processing apparatus 1 or 1A, and causes the information processing apparatus 1 or 1A to refer to a document describing the product or service. As a result, the related description related to the desired condition of the subject can be extracted from the document. Then, by causing the information processing apparatus 1 or 1A to present the extracted related description, the subject can smoothly determine whether the product or service described by the related description satisfies the desired condition, and efficiently consider purchase of the product or service.

The subject may input condition information indicating a desired condition for a desired product or service to the information processing apparatus 1B, and cause the information processing apparatus 1B to refer to a document describing the product or service. As a result, it is possible to cause the information processing apparatus 1B to output a determination result as to whether the product or the service described in the above document satisfies the desired condition. Then, the subject can efficiently consider purchase of a product or a service with reference to the presented determination result.

For example, the information processing apparatuses 1, 1A, and 1B can be used in a case of searching for a country or a region that satisfies a desired condition, a person that satisfies the desired condition, a product specification that satisfies the desired condition, and the like.

### Modified Examples

Any execution subject of each processing described in the above described exemplary example embodiment and reference example is applicable, and is not limited to the above described examples. For example, a system having functions similar to those of the information processing apparatuses 1, 1A, and 1B can be constructed by a plurality of apparatuses capable of communicating with each other. The execution subject of each processing illustrated in the flowchart illustrated in FIG. 9 may be one device (also referred to as a processor) or a plurality of apparatuses (also referred to as a processor).

### Example of Implementation by Software

Some or all of the functions of the information processing apparatuses 1, 1A, and 1B (hereinafter also referred to as “each of the above apparatuses”) may be implemented by hardware such as an integrated circuit (IC chip) or may be implemented by software.

In the latter case, each of the above apparatuses is implemented by, for example, a computer that executes a command of a program which is software for implementing each function. An example of such a computer (hereinafter, referred to as a computer C) is illustrated in FIG. 11. FIG. 11 is a block diagram illustrating a hardware configuration of the computer C functioning as each of the above apparatuses.

The computer C includes at least one processor C1 and at least one memory C2. A program (support program) P for operating the computer C as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by one processor provided in one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

### Supplementary Notes

The present disclosure includes the technologies described in the following supplementary notes. However, the present invention is not limited to the techniques described in the following supplementary notes, and various modifications can be made within the scope described in the claims.

### Supplementary Note A1

An information processing apparatus, including: acquisition means for acquiring condition information indicating a desired condition of the subject for insurance; and extraction means for extracting a related description related to the desired condition from a document describing an insurance product that is a candidate recommended to the subject by using an extraction model machine learned in such a way as to output a portion related to the data in the document using a set of the document and the data as an input.

### Supplementary Note A2

The information processing apparatus according to Supplementary Note A1, further including: determination means for determining whether the insurance product described in the related description satisfies the desired condition by using a language model that has machine learned a natural language; and presentation control means for presenting the insurance product determined by the determination means to satisfy the desired condition to the subject as a recommended insurance product.

### Supplementary Note A3

The information processing apparatus according to Supplementary Note A2, in which the determination means generates a prompt that includes the related description and the desired condition and instructs to infer a relationship between the related description and the desired condition, and determines whether the insurance product described by the related description satisfies the desired condition based on an output obtained by inputting the generated prompt to the language model.

### Supplementary Note A4

The information processing apparatus according to Supplementary Note A3, in which the determination means generates a prompt instructing to output a basis of the inference together with an inference result of the relationship between the related description and the desired condition, and the presentation control means presents the inference result output by the language model, a determination result of the determination means, or an insurance product determined by the determination means to satisfy the desired condition together with the basis.

### Supplementary Note A5

The information processing apparatus according to Supplementary Note A4, further including reception means for receiving a correction instruction for the inference result, in which the determination means redetermines whether the insurance product described by the related description satisfies the desired condition based on a correction instruction received by the reception means.

### Supplementary Note A6

The information processing apparatus according to Supplementary Note A5, in which the reception means receives a correction instruction representing a correction content in a natural language, and the determination means generates a prompt including the correction instruction received by the reception means and instructing to infer a relationship between the desired condition and the related description based on the correction instruction, and redetermines whether the insurance product described by the related description satisfies the desired condition based on an output obtained by inputting the generated prompt to the language model.

### Supplementary Note A7

The information processing apparatus according to any one of Supplementary Notes A1 to A6, further including: presentation control means for presenting history information regarding a desired condition of the subject for insurance; and reception means for receiving an input of an explanatory sentence describing the presented history information, wherein the extraction means extracts a related description related to the desired condition using a set of the history information and the explanatory sentence as one desired condition.

### Supplementary Note A8

An information processing apparatus including: acquisition means for acquiring condition information indicating a desired condition of the subject for insurance; and determination means for determining whether an insurance product satisfies the desired condition by using a document describing the insurance product and a language model trained by machine learning on natural language

### Supplementary Note B1

A support method causing at least one processor to execute: acquisition processing of acquiring condition information indicating a desired condition of the subject for insurance; and extraction processing of extracting a related description related to the desired condition from a document describing an insurance product that is a candidate recommended to the subject by using an extraction model machine learned in such a way as to output a portion related to the data in the document using a set of the document and the data as an input.

### Supplementary Note B2

The support method according to Supplementary Note B1, further including: determination processing in which the at least one processor determines whether the insurance product described in the related description satisfies the desired condition by using a language model machine learning a natural language; and presentation control processing in which the at least one processor presents the insurance product determined to satisfy the desired condition in the determination processing to the subject as a recommended insurance product.

### Supplementary Note B3

The support method according to Supplementary Note B2, in which in the determination processing, the at least one processor generates a prompt that includes the related description and the desired condition and instructs to infer a relationship between the related description and the desired condition, and determines whether the insurance product described by the related description satisfies the desired condition based on an output obtained by inputting the generated prompt to the language model.

### Supplementary Note B4

The support method according to Supplementary Note B3, in which in the determination processing, the at least one processor generates a prompt for instructing to output a basis of the inference together with an inference result of a relationship between the related description and the desired condition, and the at least one processor presents the inference result output by the language model, a determination result of the determination processing, or an insurance product determined to satisfy the desired condition in the determination processing together with the basis.

### Supplementary Note B5

The support method according to Supplementary Note B4, in which the at least one processor includes reception processing of receiving a correction instruction for the inference result, and the at least one processor redetermines whether the insurance product described by the related description satisfies the desired condition based on the correction instruction received in the reception processing.

### Supplementary Note B6

The support method according to Supplementary Note B5, in which in the reception processing, the at least one processor receives a correction instruction that represents a correction content in a natural language, and the at least one processor generates a prompt that includes the correction instruction received in the reception processing and instructs to infer a relationship between the desired condition and the related description based on the correction instruction, and redetermines whether the insurance product described by the related description satisfies the desired condition based on an output obtained by inputting the generated prompt to the language model.

### Supplementary Note B7

The support method according to any one of Supplementary Notes B1 to B6, further including: presentation control processing in which the at least one processor presents history information regarding a desired condition of the subject for insurance; and reception processing in which the at least one processor receives an input of an explanatory sentence describing the presented history information, in which in the extraction processing, the at least one processor extracts a related description related to the desired condition, using a set of the history information and the explanatory sentence as one desired condition.

### Supplementary Note B8

A support method causing at least one processor to execute acquisition processing of acquiring condition information indicating a desired condition of the subject for insurance; and determination processing of determining whether an insurance product satisfies the desired condition by using a document describing the insurance product and a language model trained by machine learning on natural language

### Supplementary Note C1

A support program causing a computer to function as: acquisition means for acquiring condition information indicating a desired condition of the subject for insurance; and extraction means for extracting a related description related to the desired condition from a document describing an insurance product that is a candidate recommended to the subject by using an extraction model machine learned in such a way as to output a portion related to the data in the document using a set of the document and the data as an input.

### Supplementary Note C2

The support program according to Supplementary Note C1, further causing the computer to function as determination means for determining whether the insurance product described in the related description satisfies the desired condition by using a language model that has machine learned a natural language; and presentation control means for presenting the insurance product determined by the determination means to satisfy the desired condition to the subject as a recommended insurance product.

### Supplementary Note C3

The support program according to Supplementary Note C2, in which the determination means generates a prompt that includes the related description and the desired condition and instructs to infer a relationship between the related description and the desired condition, and determines whether the insurance product described by the related description satisfies the desired condition based on an output obtained by inputting the generated prompt to the language model.

### Supplementary Note C4

The support program according to Supplementary Note C3, in which the determination means generates a prompt instructing to output a basis of the inference together with an inference result of the relationship between the related description and the desired condition, and the presentation control means presents the inference result output by the language model, a determination result of the determination means, or an insurance product determined by the determination means to satisfy the desired condition together with the basis.

### Supplementary Note C5

The support program according to Supplementary Note C4, further causing the computer to function as reception means for receiving a correction instruction for the inference result, in which the determination means redetermines whether the insurance product described by the related description satisfies the desired condition based on the correction instruction received by the reception means.

### Supplementary Note C6

The support program according to Supplementary Note C5, in which the reception means receives a correction instruction representing a correction content in a natural language, and the determination means generates a prompt including the correction instruction received by the reception means and instructing to infer a relationship between the desired condition and the related description based on the correction instruction, and redetermines whether the insurance product described by the related description satisfies the desired condition based on an output obtained by inputting the generated prompt to the language model.

### Supplementary Note C7

The support program according to any one of Supplementary Notes C1 to C6, further causing the computer to function as presentation control means for presenting history information regarding a desired condition of the subject for insurance; and reception means for receiving an input of an explanatory sentence describing the presented history information, in which the extraction means extracts a related description related to the desired condition using a set of the history information and the explanatory sentence as one desired condition.

### Supplementary Note C8

A support program causing a computer to function as acquisition means for acquiring condition information indicating a desired condition of the subject for insurance; and determination means for determining whether an insurance product satisfies the desired condition by using a document describing the insurance product and a language model trained by machine learning on natural language

### Supplementary Note D1

An information processing apparatus including at least one processor, causing the at least one processor to execute: acquisition processing of acquiring condition information indicating a desired condition of the subject for insurance; and extraction processing of extracting a related description related to the desired condition from a document describing an insurance product that is a candidate recommended to the subject by using an extraction model machine learned in such a way as to output a portion related to the data in the document using a set of the document and the data as an input.

The information processing apparatus may further include a memory. The memory may store a program for causing the at least one processor to execute each of the processing.

### Supplementary Note D2

The information processing apparatus according to Supplementary Note D1, further causing the at least one processor to execute determination processing of determining whether the insurance product described in the related description satisfies the desired condition by using a language model machine learning a natural language; and presentation control processing of presenting the insurance product determined to satisfy the desired condition in the determination processing to the subject as a recommended insurance product.

### Supplementary Note D3

The information processing apparatus according to Supplementary Note D2, in which in the determination processing, the at least one processor generates a prompt that includes the related description and the desired condition and instructs to infer a relationship between the related description and the desired condition, and determines whether the insurance product described by the related description satisfies the desired condition based on an output obtained by inputting the generated prompt to the language model.

### Supplementary Note D4

The information processing apparatus according to Supplementary Note D3, in which in the determination processing, the at least one processor generates a prompt for instructing to output a basis of the inference together with an inference result of a relationship between the related description and the desired condition, and the at least one processor presents the inference result output by the language model, a determination result in the determination processing, or an insurance product determined to satisfy the desired condition in the determination processing together with the basis.

### Supplementary Note D5

The information processing apparatus according to Supplementary Note D4, in which the at least one processor executes reception processing of receiving a correction instruction for the inference result, and in the determination processing, the at least one processor redetermines whether the insurance product described by the related description satisfies the desired condition based on the correction instruction received in the reception processing.

### Supplementary Note D6

The information processing apparatus according to Supplementary Note D5, in which in the reception processing, the at least one processor receives a correction instruction that represents a correction content in a natural language, generates a prompt that includes the correction instruction received in the reception processing and instructs to infer a relationship between the desired condition and the related description based on the correction instruction, and redetermines whether the insurance product described by the related description satisfies the desired condition based on an output obtained by inputting the generated prompt to the language model.

### Supplementary Note D7

The information processing apparatus according to any one of Supplementary Notes D1 to D6, further causing the at least one processor to execute presentation control processing of presenting history information regarding a desired condition of the subject for insurance; and reception processing of receiving an input of an explanatory sentence describing the presented history information, in which the extraction processing, at least one processor extracts a related description related to the desired condition using a set of the history information and the explanatory sentence as one desired condition.

### Supplementary Note D8

An information processing apparatus including at least one processor, causing the at least one processor to execute acquisition processing of acquiring condition information indicating a desired condition of the subject for insurance; and determination processing of determining whether an insurance product satisfies the desired condition by using a document describing the insurance product and a language model trained by machine learning on natural language

### Supplementary Note E1

A non-transitory recording medium recording a support program for causing a computer to execute: acquisition processing of acquiring condition information indicating a desired condition of the subject for insurance; and extraction processing of extracting a related description related to the desired condition from a document describing an insurance product that is a candidate recommended to the subject by using an extraction model machine learned in such a way as to output a portion related to the data in the document using a set of the document and the data as an input.

### Supplementary Note E2

A non-transitory recording medium recording a support program for causing a computer to execute acquisition processing of acquiring condition information indicating a desired condition of the subject for insurance; and determination processing of determining whether an insurance product satisfies the desired condition by using a document describing the insurance product and a language model trained by machine learning on natural language.

1. An information processing apparatus, comprising:
at least one memory storing instructions; and
at least one processor configured to execute the instructions to;
acquire condition information indicating a desired condition of the subject for insurance; and
extract a related description related to the desired condition from a document describing an insurance product that is a candidate recommended to the subject by using an extraction model with machine learning in such a way as to output a portion related to the data in the document using a set of the document and the data as an input.

2. The information processing apparatus according to claim 1, the at least one processor is further configured to execute the instructions to
determine whether the insurance product described in the related description satisfies the desired condition by using a language model that has machine learned a natural language; and
present the insurance product determined to satisfy the desired condition to the subject as a recommended insurance product.

3. The information processing apparatus according to claim 2, the at least one processor is further configured to execute the instructions to
generate a prompt that includes the related description and the desired condition and instructs to infer a relationship between the related description and the desired condition; and
determine whether the insurance product described by the related description satisfies the desired condition based on an output obtained by inputting the generated prompt to the language model.

4. The information processing apparatus according to claim 3, the at least one processor is further configured to execute the instructions to
generate a prompt instructing to output a basis of the inference together with an inference result of the relationship between the related description and the desired condition; and
present the inference result output by the language model, a determination result by determined, or an insurance product determined to satisfy the desired condition together with the basis.

5. The information processing apparatus according to claim 4, the at least one processor is further configured to execute the instructions to
receive a correction instruction for the inference result; and
redetermines whether the insurance product described by the related description satisfies the desired condition based on a correction instruction received.

6. The information processing apparatus according to claim 5, the at least one processor is further configured to execute the instructions to
receive a correction instruction representing a correction content in a natural language; and
generate a prompt including the correction instruction received and instructing to infer a relationship between the desired condition and the related description based on the correction instruction, and redetermines whether the insurance product described by the related description satisfies the desired condition based on an output obtained by inputting the generated prompt to the language model.

7. The information processing apparatus according to claim 1, the at least one processor is further configured to execute the instructions to
present history information regarding a desired condition of the subject for insurance;
receive an input of an explanatory sentence describing the presented history information; and
extract a related description related to the desired condition using a set of the history information and the explanatory sentence as one desired condition.

8. A support method causing at least one processor to execute:
acquisition processing of acquiring condition information indicating a desired condition of the subject for insurance; and
extraction processing of extracting a related description related to the desired condition from a document describing an insurance product that is a candidate recommended to the subject by using an extraction model with machine learning in such a way as to output a portion related to the data in the document using a set of the document and the data as an input.

9. A non-transitory recording medium recording a support program for causing a computer to execute: acquisition processing of acquiring condition information indicating a desired condition of the subject for insurance; and extraction processing of extracting a related description related to the desired condition from a document describing an insurance product that is a candidate recommended to the subject by using an extraction model with machine learning in such a way as to output a portion related to the data in the document using a set of the document and the data as an input.
